(19) United States
(12) Patent Application Publication
(10) Pub. No.: US 2003/0039004 A1
(43) Pub. Date: Feb. 27, 2003

(54) Light switch

(76) Inventor: Hisayuki Hirayama, Chiba-shi (JP)

Correspondence Address: ADAMS & WILKS, ATTORNEYS AND COUNSELORS AT LAW, 31ST FLOOR, 50 BROADWAY, NEW YORK, NY, 10004, US

(21) Appl. No.: 10/199,821

(22) Filed: Jul. 19, 2002

(30) Foreign Application Priority Data
Aug. 23, 2001 (JP) 2001-252575

(51) Int. Cl. H04J 14/00

(52) U.S. Cl. 359/117

(57) ABSTRACT

In a light switch which comprises juxtaposed plural fixed optical fibers, at least one movable optical fiber becoming freely movable to a position where its end face is mutually opposed to those of the fixed optical fibers, a magnetic body provided in the vicinity of a tip of the movable optical fiber, a drive coil disposed around the magnetic body, and 1st and 2nd permanent magnets disposed in both outer sides in a moving direction of the movable optical fiber of the drive coil, and in which a switching of a light transmission path is performed by a movement of the movable optical fiber, there is provided a position sensor comprising an exciting coil connected electrically parallel to the drive coil, and a switch in which a 1st state and a 2nd state are switched by means of a magnetic field generated by an electric current supplied to the exciting coil and the 1st or 2nd state is held.

### BACKGROUND OF THE INVENTION

1. Field of the Invention

The present invention relates to a light switch for performing a switching of a light transmission path by moving an optical fiber.

2. Description of the Related Art

Hitherto, as the light switch for performing the switching of the light transmission path of the optical fiber, there is known a mechanical light switch which has a movable optical fiber and plural fixed optical fibers and in which the switching of the light transmission path is performed by directly moving the movable optical fiber to thereby cause its end face to mutually oppose to an end face of any of the fixed optical fibers.

In this mechanical light switch, a movement of the movable optical fiber is performed by means of forming, by a drive coil, magnetic poles in a magnetic body coated on a tip portion of the movable optical fiber and of utilizing an interaction between repulsion and attraction by a permanent magnet.

Further, after the magnetic poles have been temporarily formed in the magnetic body by the drive coil, even under a state that the drive coil is not energized, i.e., even if no magnetic poles are formed in the magnetic body, the magnetic body moved to one side is held in its moved state by the attraction of the permanent magnet, so that the light transmission path between the movable optical fiber and the fixed optical fiber is self-held.

However, with such a conventional self-holding type light switch, there is a problem that by only the light switch it is impossible to discriminate to which fixed optical fiber the movable optical fiber is optically connected under an initial state after assembly and when the switching of the light transmission path is performed by actually carrying out the connection.

### SUMMARY OF THE INVENTION

In view of such a circumstance, it is a problem of the invention to provide a light switch capable of easily and surely discriminate a switched state of the light transmission path.

A first mode of the invention solving the problem is a light switch which comprises juxtaposed plural fixed optical fibers, at least one movable optical fiber becoming freely movable to a position where its end face is mutually opposed to those of the fixed optical fibers, a magnetic body provided in the vicinity of a tip of the movable optical fiber, a drive coil disposed around the magnetic body, and 1st and 2nd permanent magnets disposed in both outer sides in a moving direction of the movable optical fiber of the drive coil, and in which a switching of a light transmission path is performed by a movement of the movable optical fiber, characterized in that there is provided a position sensor comprising an exciting coil connected electrically parallel to the drive coil, and a switch in which a 1st state and a 2nd state are switched by means of a magnetic field generated by an electric current supplied to the exciting coil and the 1st or 2nd state is held.

A 2nd mode of the invention is a light switch characterized in that, in the 1st mode, the drive coil and the exciting coil are driven by approximately equal drive pulses.

A 3rd mode of the invention is a light switch characterized in that, in the 1st or 2nd mode, the position sensor is provided with a movable portion which consists of a magnetic body and which is moved by a magnetic field generated in the exciting coil, and a movement of the movable portion interlocks with a switching of the switch.

A 4th mode of the invention is a light switch characterized in that, in the 3rd mode, the position sensor is provided with a permanent magnet for holding the 1st and 2nd states of the movable portion.

A 5th mode of the invention is a light switch characterized in that, in any of the 1st-4th modes, the position sensor is a latching relay in which the switch is an electrical switch.

A 6th mode of the invention is a light switch characterized in that, in any of the 1st-5th modes, in the position sensor the 1st and 2nd states of the switch can be visually observed.

A 7th mode of the invention is a light switch characterized in that, in any of the 1st-6th modes, the position sensor is provided with discrimination means for electrically discriminating the 1st state or the 2nd state of the switch.

In the present invention, the switching of the light transmission path of the light switch can be distinguished by the position sensor in which the state is switched by being energized. Therefore, an erroneous connection can be surely prevented by confirming a switched state of the light switch.

### BRIEF DESCRIPTION OF THE DRAWINGS

FIG. 1 is a perspective view of a light switch according to an embodiment 1 of the invention;

FIG. 2A is a view including a schematic sectional view of the light switch according to the embodiment 1 of the invention and a circuit diagram of a position sensor;

FIG. 2B is a sectional view taken along a dashed line B-B in FIG. 2A;

FIG. 3A is a side view of a position sensor according to the embodiment 1 of the invention;

FIG. 3B is a bottom view of a movable planar plate; and

FIG. 4A and FIG. 4B are views each including a schematic sectional view showing a switching of the light switch according to the embodiment 1 of the invention and a circuit diagram of the position sensor.

### DETAILED DESCRIPTION OF THE INVENTION

Hereunder, the invention is detailedly described on the basis of embodiments.

(Embodiment 1)

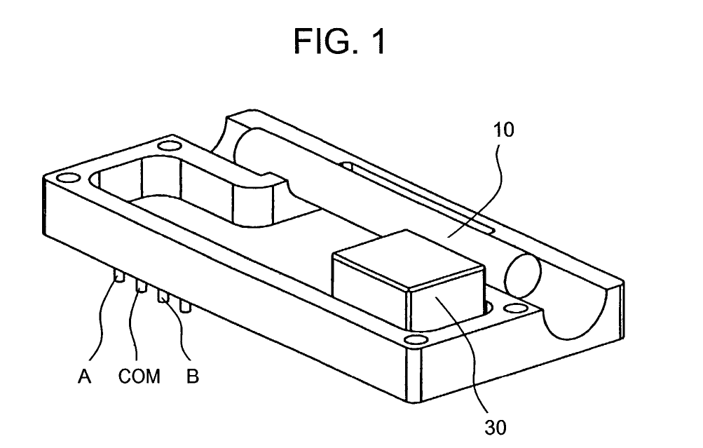

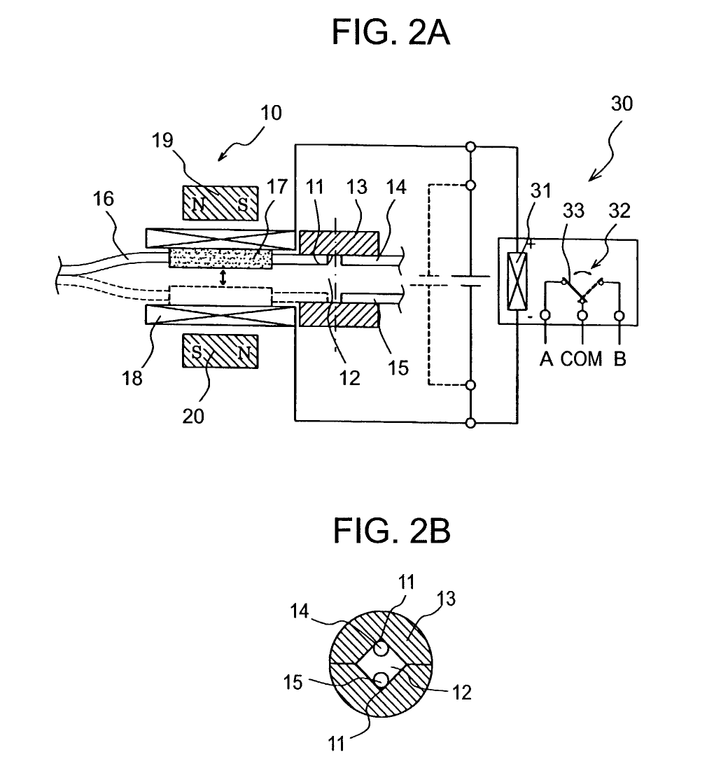

FIG. 1 is a perspective view of a light switch according to an embodiment 1 of the invention. FIG. 2A is a view including a schematic sectional view of the light switch and a circuit diagram of a position sensor. FIG. 2B is a sectional view taken along a dashed line B-B in FIG. 2A;

As shown in the drawings, the light switch of this embodiment is a light switch of 1×2 type having one input port and two output ports, and therein there are provided a light switch body 10 and a position sensor 30 for distinguishing a state of light transmission path in the light switch body 10.

The light switch body 10 comprises a fixed member 13 having an insertion hole 12 in which groove portions 11 whose section is formed in V-shape are provided so as to mutually oppose, 1st and 2nd fixed optical fibers 14 and 15 positioned and fixed respectively to the groove portions 11 at one end portion side of the insertion hole 12 of the fixed member 13, and a movable optical fiber 16 provided at the other end portion side in the insertion hole 12 of the fixed member 13 and provided so as to be freely movable in the insertion hole 12 in a radial direction.

In the groove portion 11, at an upper side in the drawing, of the insertion hole 12 of the fixed member 13 there is positioned and fixed the 1st fixed optical fiber 14, and in the groove portion 11 at a lower side in the drawing there is positioned and fixed the 2nd fixed optical fiber 15.

Further, at the other end portion side of the insertion hole 12, the movable optical fiber 16 is provided so as to be freely movable in the insertion hole 12 so that its end face can oppose mutually to end faces of the 1st and 2nd fixed optical fibers 14 and 15. Detailedly, the movable optical fiber 16 is made movable in the insertion hole 12 by fixing a predetermined position of the movable optical fiber 16 so that a tip of the movable optical fiber 16 becomes a free end.

Additionally, a vicinity of the tip having become the free end of the movable optical fiber 16 is covered with a magnetic pipe 17 consisting of a magnetic body having desired magnetic characteristics. The magnetic pipe 17 is provided so that a tip portion of the movable optical fiber 16 is exposed by a predetermined amount. And, it is adapted such that, when the movable optical fiber 16 is moved, only the tip portion of the movable optical fiber 16 not covered with the magnetic pipe 17 butts against the groove portion 11 of the insertion hole 12, so that its end face opposes mutually to any one of end faces of the 1st and 2nd fixed optical fibers 14 and 15.

Further, at an outer periphery of the magnetic pipe 17 provided in a tip portion side of the movable optical fiber 16, magnetic poles are formed in the magnetic pipe 17. For example, there is provided a drive coil 18 consisting of a solenoid coil in which a wire is wound cylidrically or spirally, and 1st and 2nd permanent magnets 19 and 20 having approximately the same magnetic force are provided outside the drive coil 18 correspondingly to the 1st and 2nd fixed optical fibers 14 and 15. Detailedly, the 1st permanent magnet 19 is provided at a 1st fixed optical fiber 14 side, and the 2nd permanent magnet 20 is provided at a 2nd fixed optical fiber 15 side.

The drive coil 18 generates a magnetic field in its inside by flowing an electric current, and moves the magnetic pipe 17 and the movable optical fiber 16 to either one side of the 1st and 2nd permanent magnets 19 and 20 by forming the magnetic poles in the magnetic pipe 17.

Further, the current is flowed through the drive coil 18 only when the magnetic pipe 17 is moved. And, it is adapted such that the magnetic pipe 17 moved by the magnetic field of the drive coil 18 is self-held by the attraction of the 1st or 2nd permanent magnet 19 or 20 even under a state that no magnetic poles are formed by the drive coil 18.

On the other hand, to the light switch body 10 there is connected the position sensor 30 for discriminating to which of the 1st or 2nd fixed optical fiber 14 or 15 the movable optical fiber 16 is held at a position where both are mutually opposed.

The position sensor 30 comprises an exciting coil 31 provided electrically parallel to the drive coil 18 of the light switch body 10, and a switch 32 in which a 1st state and a 2nd state are switched by the magnetic field of the exciting coil 31 and in which the 1st or 2nd state is held.

The switch 32 of this embodiment is provided with a movable portion 33 formed of a magnetic body. A switching between the 1st state and the 2nd state of the switch 32 means the fact that the movable portion 33 is moved by means of the magnetic field generated by the exciting coil 31 to thereby conduct a COM port connected to the movable portion 33 to any one of 1st and 2nd fixed contacts A and B.

Further, the switch 32 is provided with a holding mechanism for self-holding a moved state of the movable portion 33 even under a state that the exciting coil 31 is not energized. This holding mechanism is not limited especially, and for example it may be one that magnetically self-holds the movable portion 33 or one that mechanically self-holds it.

In the position sensor 30, since a direction of the magnetic field generated by the exciting coil 31 similarly to the drive coil 18 is determined by an energizing direction along which the drive coil 18 is energized, a position of the movable portion 33 is switched by the energizing direction of the drive coil 18, i.e., by a switching of the light transmission path. By this, only by discriminating the position of the movable portion 33, a switched state of the light transmission path of the light switch body 10 can be distinguished.

Incidentally, as to a discrimination of the position of the movable portion 33, for example it may be adapted so that the position can be distinguished by a visual observation by means of providing the position sensor 30 or the switch 32 in a transparent or translucent armoring case and of making a moved position of the movable portion 33 into a 1st state and a 2nd state. Further, it may be adapted such that the position is distinguished by connecting a light emitting diode such as LED to the COM port of the switch 32 and any one of the 1st or 2nd fixed contact A or B, and by making it the 1st sate when the light emitting diode emits the light and making it the second state when it emits no light.

As such a position sensor 30, it is possible to enumerate a contact-possessing type latching relay for instance. Here, it is explained about one example of the latching relay.

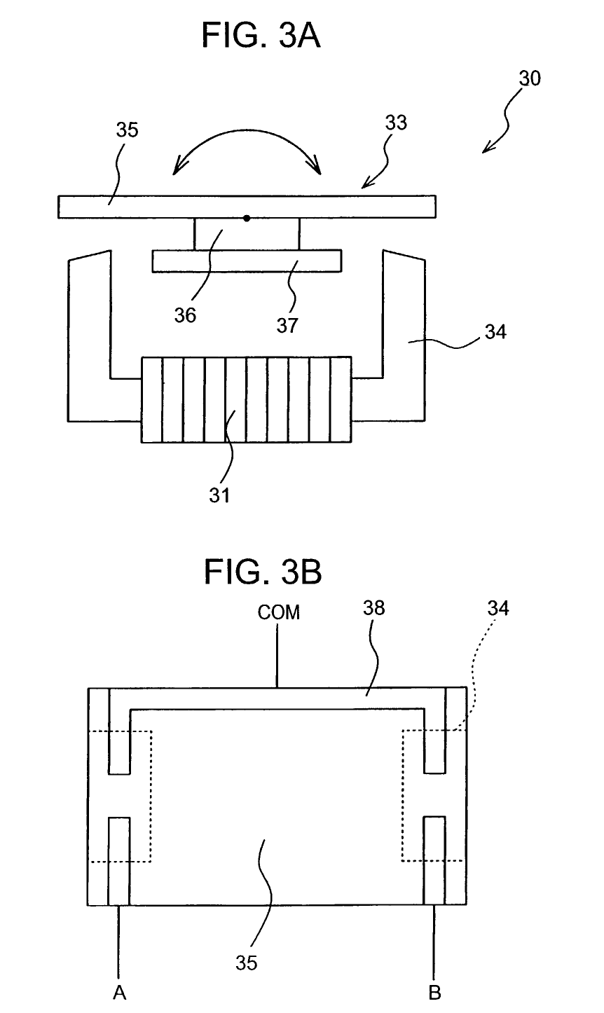

FIG. 3A is a side view of the position sensor, and FIG. 3B a bottom view of a movable planar plate.

As shown in the drawings, the position sensor 30 consisting of the latching relay has an iron core portion 34 formed in a U-shape, the exciting coil 31 which is disposed about an outer periphery of the iron core portion 34 to form the magnetic poles in the iron core portion 34 and which is provided electrically parallel to the drive coil 18 of the light switch body 10, and the movable portion 33 rotatably provided so as to butt against any one of end faces of the iron core portion 34.

The movable portion 33 has a movable planar plate 35 butting against the end face of the exciting coil 31, a permanent magnet 36 bonded to an exciting coil 31 side of the movable planar plate 35, and an iron piece 37 provided so as to sandwich the permanent 36 between it and the movable planar plate 35.

Further, at an iron core portion 34 side of the movable planar plate 35, there is provided a wiring pattern 38 electrically connected to the COM port and the 1st and 2nd fixed contacts A and B so as to conduct at the end face of the iron core portion 34, and it is adapted such that the wiring pattern 38 is conducted at the end face of the iron core portion 34 with a movement of the movable portion 33.

In the movable planar plate 35 of such a movable portion 33, the magnetic poles are formed by the permanent magnet 36, and it is adapted such that the movable planar plate 35 is rotated to any one side of the end faces of the iron core portion 34 by means of the repulsion and the attraction of the magnetic field generated by energizing the exciting coil 31, so that the wiring pattern 38 on the movable planar plate 35 is conducted by the end face of the iron core portion 34.

On this occasion, even under a state that the exciting coil 31 is not energized, since the magnetic poles are formed in the movable planar plate 35 by the permanent magnet 36, it is adapted such that the movable planar plate 35 is self-held under a state that it butts against any one of the end faces of the iron core portion 34.

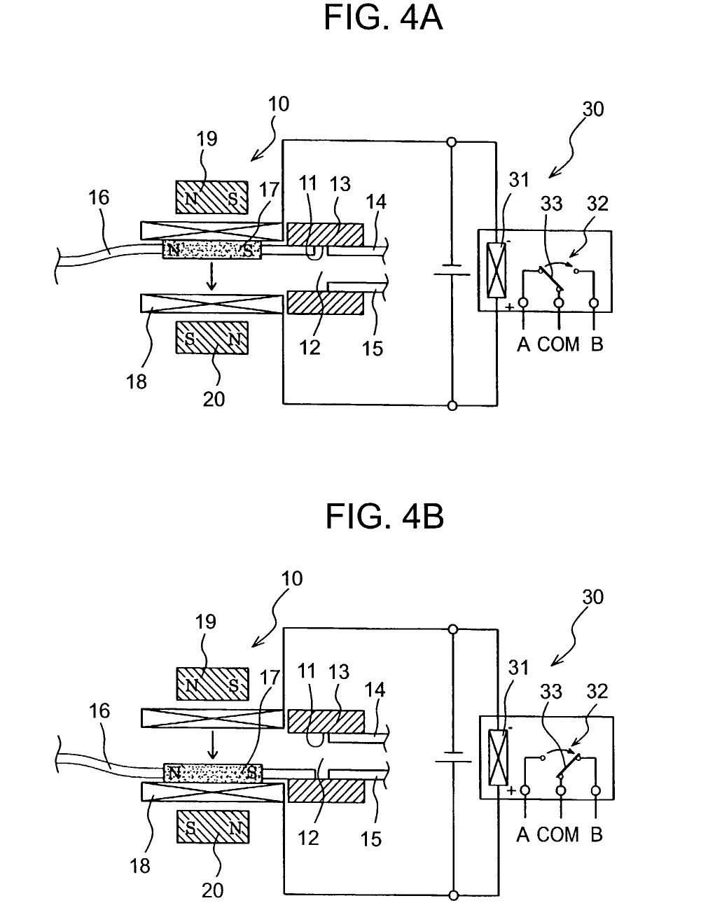

Here, it is explained about an operation of the position sensor 30 interlocking with a switching of the light transmission path of the light switch body 10 of this embodiment. Incidentally, FIG. 4A and FIG. 4B are views each including a schematic sectional view showing the switching of the light switch and a circuit diagram of the position sensor.

For example, in an initial state such as when shipped from a factory, the movable fiber 16 is self-held under a state that its end face is mutually opposed to any one of the end faces of the fixed optical fibers 14, 15. In this embodiment, as shown in FIG. 4A, first the movable optical fiber 16 is explained as one self-held to a 1st permanent magnet 19 side.

First, as shown in FIG. 4A, from the state that the movable optical fiber 16 is self-held to the 1st permanent magnet 19 side, a magnetic field is temporarily generated in the drive coil 18 by energizing the drive coil 18. By this magnetic field generated by the drive coil 18, the magnetic poles repulsing against the 1st permanent magnet 19 and attracted by the 2nd permanent magnet 20 are formed in the magnetic pipe 17 covering the tip portion of the movable optical fiber 16.

As shown in FIG. 4B, the tip portion of the movable optical fiber 16 covered with the magnetic pipe 17 in which the magnetic poles have been formed is moved from a position opposing to the 1st fixed optical fiber 14 to the 2nd permanent magnet 20 side by means of an interaction between magnetic forces by the 1st permanent magnet 19 and the 2nd permanent magnet 20, so that an optical connection is performed by mutually opposing its end face to the end face of the 2nd fixed optical fiber 15. And, even if it is stopped to energize the drive coil 18, the magnetic pipe 17 is self-held by the magnetic force of the 2nd permanent magnet 20 under a state of being optically connected to the 2nd fixed optical fiber 15.

On this occasion, by energizing the drive coil 18, the exciting coil 31, of the position sensor 30, provided electrically parallel to the drive coil 18 is also energized, thereby temporarily generating a magnetic field in the exciting coil 31. By means of this magnetic field generated by the exciting coil 31, the movable portion 33 is moved to a 2nd fixed contact B side to thereby electrically conduct the COM port to the 2nd fixed contact B by means of an interaction between the magnetic poles in the both end faces of the iron core portion 34 by the exciting coil 31. And, even if it is stopped to energize the exciting coil 31, the movable portion 33 is self-held under a state of being moved to the 2nd fixed contact B side, i.e., under a state that the COM port and the 2nd fixed contact B are conducted.

In order to switch the light transmission path of the light switch from such a state, the drive coil 18 is energized in a direction reverse to the aforesaid energizing direction from the state that the movable optical fiber 16 is self-held to the 2nd permanent magnet 20 side, thereby generating an electric field in the drive coil 18 in the reverse direction. By this, in the magnetic pipe 17 there is formed the magnetic poles in a direction repulsing against the 2nd permanent magnet 20 and attracted by the 1st permanent magnet 19. By this, the magnetic pipe 17 is moved to the 1st permanent magnet 19 side by the interaction between the 1st permanent magnet 19 and the 2nd permanent magnet 20, so that the movable optical fiber 16 is optically connected to the 1st fixed optical fiber 14 with their end faces being mutually opposed. On this occasion, even if it is stopped to energize the drive coil 18, the magnetic pipe 17 is self-held by the magnetic force of the 1st permanent magnet 19 under a state that its end face is mutually opposed to the end face of 1st fixed optical fiber 14.

On this occasion, by energizing the drive coil 18, also the exciting coil 31 of the position sensor 30 provided electrically parallel to the drive coil 18 is similarly energized, thereby temporarily generating a magnetic field in the exciting coil 31. By this magnetic field generated by the exciting coil 31, the movable portion 33 is moved to a 1st fixed contact A side by means of the interaction between the magnetic poles at both end faces of the iron core portion 34 by the exciting coil 31, thereby electrically conducting the COM port and the 1st fixed contact A. And, even if it is stopped to energize the exciting coil 31, the movable portion 33 is self-held under a state of being moved to the 1st fixed contact A side, i.e., a state that the COM port and the 1st fixed contact A are conducted.

In such a light switch 10, by temporarily energizing the drive coil 18 in order to drive the movable optical fiber 16, also the exciting coil 31 of the position sensor 30 is temporarily energized. Since the movable portion 33 is moved by a magnetic field of this exciting coil 31 and a moved state of the movable portion 33 is self-held, the light transmission path can be easily distinguished by discriminating the position of the movable portion 33.

Further, since the light transmission path can be distinguished only by discriminating the position of the movable portion 33, it is possible to easily discriminate to which fixed optical fiber 14 or 15 the optical connection is made by visually observing the light switch even under a state that the light switch is being used.

Additionally, before shipping such a light switch, since the transmission path of the light switch can be distinguished by once energizing the drive coil 18 and the exciting coil 31, an erroneous connection and the like can be surely prevented.

(Other Embodiments)

In the above, the embodiment 1 of the invention has been described, but the light switch of the invention is not limited to one mentioned above.

In the embodiment 1, a one-wound latching relay in which only one exciting coil 31 is provided has been exemplified as the position sensor 30, but it is not limited to this. For example, there may be adopted a position sensor consisting of a two-wound latching relay composed of two exciting coils of a set coil and a reset coil.

Further, in the embodiment 1, the switch 32 has been an electric switch by providing the 1st and 2nd fixed contacts A and B in the switch 32, but it is not limited to this. For example, if it is adapted such that the position sensor or the switch is provided in a transparent or translucent armoring case without providing the fixed contacts so that the moved state of the movable portion can be visually observed, a switched state of the light transmission path can be discriminated by means of confirming the moved state of the movable portion by a visual observation. Therefore, the position sensor is not limited to the latching relay which is the electric switch, and it may be one in which the movable portion is merely moved.

Further, the holding of the moved state of the movable portion may be one by the magnetic field or one mechanically held.

Additionally, in the embodiment 1, the contact-possessing latching relay has been exemplified as the position sensor, but it is not limited to this so long as it is a relay in which a 1st state and a 2nd state are switched and the 1st state or the 2nd state is held. For example, there may be adopted a contact-less relay utilizing a semiconductor and the like, or there may be adopted a hybrid relay in which a contact-possessing relay and a contact-less relay are combined.

Further, in the embodiment 1, the 1×2 type light switch having one input port and two output ports has been exemplified, but it is not limited to this. For example, there may be adopted a 2×4 type light switch consisting of two input ports and four output ports, in which there are provided two movable optical fibers and there are provided four fixed optical fibers whose end faces are mutually opposed to end faces of the two movable optical fibers. Further, there may be adopted a 1×X type light switch having one input port and plural output ports by connecting plural light switches of the embodiment 1.

An M×N type light switch can be easily formed by combining the light switches in this manner, and the discrimination of the light transmission path can be easily distinguished by the position sensors by means of providing the position sensor in each of the light switches.

As described above, according to the light switch of the invention, since it is adapted such that there is provided the position sensor comprising the exciting coil provided electrically parallel to the drive coil, and the switch in which the 1st state and the 2nd state are switched by the exciting coil and the switched state is held, the light transmission path can be easily distinguished by discriminating the state of the switch by means of temporarily energizing the drive coil. Further, when shipping the light switch for instance, since the transmission path of the light switch can be distinguished by temporarily energizing the drive coil and the exciting coil, an erroneous connection and the like can be surely prevented.

What is claimed is:

1. A light switch which comprises: a plurality of optical fibers fixed in parallel, at least one movable optical fiber movable to a position where its end face is mutually opposed to those of the fixed optical fibers, a magnetic body provided in the vicinity of a tip of the movable optical fiber, a drive coil disposed around the magnetic body, a 1st permanent magnet and 2nd permanent magnet disposed in both outer sides in a moving direction of the movable optical fiber of the drive coil, a position sensor having an exciting coil connected electrically parallel to the drive coil, and a switch in which a 1st state and a 2nd state are switched by means of a magnetic field generated by an electric current supplied to the exciting coil and the 1st or 2nd state is held.

2. A light switch as claimed in claim 2, wherein the position sensor is provided with a permanent magnet for holding the 1st and 2nd states of the movable portion.

3. Alight switch as claimed in claim 1, wherein the position sensor is a latching relay in which the switch is an electrical switch.

4. A light switch as claimed in claim 1, wherein the position sensor the 1st and 2nd states of the switch can be visually observed.

5. Alight switch as claimed in claim 1, wherein the position sensor is provided with discrimination means for electrically discriminating the 1st state or the 2nd state of the switch.
